(19) United States
(12) Patent Application Publication
(10) Pub. No.: US 2007/0131520 A1
(43) Pub. Date: Jun. 14, 2007

(54) Sensor mounting system for a conveyor

(75) Inventors: Joseph Edward Saunders, Wadsworth, OH (US); Gary Michael Frigyes, Paris, OH (US); Tareq Z. Murad, Beachwood, OH (US); Hermann Michael Wieth, Chagrin Falls, OH (US)

Correspondence Address: Jonathan A. Withrow;Fay, Sharpe, Fagan, Minnich & McKee, LLP, Seventh Floor, 1100 Superior Avenue, Cleveland, OH, 44114-2579, US

(73) Assignee: Pepperl + Fuchs, Inc.

(21) Appl. No.: 11/296,917

(22) Filed: Dec. 8, 2005

(51) Int. Cl. G08B 23/00; H01R 13/73

(52) U.S. Cl. 198/502.1; 439/550; 340/693.9; 248/27.1

(57) ABSTRACT

An assembly for a conveyor system includes a conveyor side rail and a sensor mounting device. The conveyor side rail includes an outer surface, an inner surface, and an opening. The inner surface is the surface generally facing moving components of an associated conveyor system. The sensor mounting device is received in the opening of the conveyor side rail. The sensor mounting device is configured to secure to the conveyor side rail via a resilient fit by an inserting the sensor mounting device into the opening. An associated sensor for the associated conveyor system selectively attaches to the sensor mounting device.

### BACKGROUND

Sensors are mounted along a conveyor system to provide information to operators and operating systems. To mount the sensor along the conveyor system, typically a metal bracket is bolted to a conveyor side rail of the conveyor system. The sensor mounts to the metal bracket that is located on an outer side of the conveyor rail and a plastic nut fastens the sensor to the bracket from an inner side of the conveyor rail. This mounting method requires a technician to reach from the outer side around to the inner side of the conveyor side rail to fasten the sensor to the mounting bracket. Especially where a number of sensors are to be mounted to a conveyor system, this mounting method is very time consuming and therefore costly.

### SUMMARY OF THE INVENTION

An assembly for a conveyor system includes a conveyor side rail and a sensor mounting device. The conveyor side rail includes an outer surface, an inner surface, and an opening. The inner surface is the surface generally facing moving components of an associated conveyor system. The sensor mounting device is received in the opening of the conveyor side rail. The sensor mounting device is configured to secure to the conveyor side rail via a resilient fit by an inserting the sensor mounting device into the opening. An associated sensor for the associated conveyor system selectively attaches to the sensor mounting device.

In a conveyor system, a method of installing a sensor includes inserting a sensor mounting device into an opening in a conveyor side rail and securing a sensor into the sensor mounting device. The sensor mounting device includes a flexible tab that is configured to engage the conveyor side rail. The device is inserted in a manner such that as the device is moving in an insertion direction the flexible tab moves in a first direction and as the device is moved further in the insertion direction the flexible tab moves in a second direction to engage the side rail.

A conveyor system assembly includes a conveyor side rail and a sensor mounting device. The conveyor side rail includes a mounting hole. The sensor mounting device is received in the mounting hole. The sensor mounting device includes a body defining an opening configured to receive an associated sensor and a resilient tab that engages the side rail upon insertion of the device into the opening.

### BRIEF DESCRIPTION OF THE FIGURES

FIG. 1 is a perspective view of a sensor mounting device prior to insertion into an opening of a conveyor side rail.

FIG. 2 is a perspective view of the sensor mounting device shown in FIG. 1.

FIG. 3 is a side cross-sectional view showing the sensor mounting device inserted into the conveyor side rail.

FIG. 4 is a perspective view of the sensor mounting device inserted into the conveyor side rail and a sensor prior to insertion into the sensor mounting device.

FIG. 5 is a perspective view of the sensor of FIG. 4.

FIG. 6 is a front elevation view of the sensor inserted into the sensor mounting device prior to rotating the sensor into a locked position.

FIG. 7 is a front elevation view of the sensor inserted into the sensor mounting device with the sensor rotated into the locked position.

FIG. 8 is a side cross-sectional view of the sensor and sensor mounting device in the locked position as shown in FIG. 7.

FIG. 9 is a perspective view of an alternative embodiment of a sensor mounting device.

### DETAILED DESCRIPTION

As seen in FIG. 1, sensor mounting devices 10 mount to a conveyor side rail 12 of a conveyor system C. The conveyor system with which the sensor mounting device 10 and the conveyor side rail 12 are to be used is the known type of conveyor system that moves items in or around a facility. Nevertheless, the sensor mounting device 10 and/or conveyor side rail 12 may also be used with other conveyor systems that have not yet been developed. The sensor mounting device 10 quickly connects to the conveyor side rail 12 and does not require a technician to reach around from an outer surface to an inner surface of the conveyor side rail, or vice versa, to attach either the sensor mounting device or a sensor (not shown in FIG. 1) to the conveyor side rail. The quick-connect, snap-fitting, sensor mounting device 10 greatly increases the speed at which sensors can be mounted to a conveyor system. The sensor mounting device is also a simplified device as compared to an existing mounting device, thereby lowering the cost for mounting devices. It is to be appreciated that conveyor system assemblies may contain large numbers of sensors. Therefore providing a fast cost efficient manner of inserting sensors will generate much greater efficiencies in the construction of new conveyor systems, as well as retrofitting existing systems. An aspect which permits the increased speed of the insertion is that the sensor mounting device 10 can be secured within the conveyor side rail 12 without the use of tools, but rather may be hand inserted. Additionally, the sensor, as will be explained in greater detail below, can be located and locked into position within the mounting device by hand insertion, i.e. without tools, and as mentioned above, the mounting device is configured so that these insertion tasks are accomplished by a technician from a single side of the conveyor side rail 12. In one embodiment it is preferred these actions take place on the side opposite the moving components, e.g. belt B, of the conveyor system C, to avoid the technician from interfering with or causing damage on the conveyor side.

The conveyor side rail 12 in the depicted embodiment is made from steel or another durable material. In one embodiment, the conveyor side rail 12 is formed from 10 gauge steel, which has a nominal thickness of 0.135 inches. Other gauges, for example 11-12 gauge, can also be used. The conveyor side rail 12 can be a conventional conveyor side rail, for example where sensor mounting devices are to be mounted to existing side rails in a retrofit installation. The conveyor side rail 12 includes integral flanges 14 (only one shown in FIG. 1) at the upper and lower edges of the conveyor side rail. The conveyor side rail 12 also includes an outer planar surface 16 and an inner planar surface 18. The inner planar surface 18 is situated closer to and generally faces the moving components of the conveyor system.

The conveyor side rail 12 includes a plurality of mounting holes 22 that receive the sensor mounting devices 10. In the depicted embodiment, each mounting hole 22 is circular in configuration; however, the mounting holes can take other configurations such as square, elliptical, and the like. The shape and dimensions of the mounting hole 22 is such that it can accommodate the sensor mounting device 10. Even though the mounting hole 22 is depicted as surrounded by the side rail 12, the mounting hole need not be surrounded by the side rail, for example the mounting hole includes a notch.

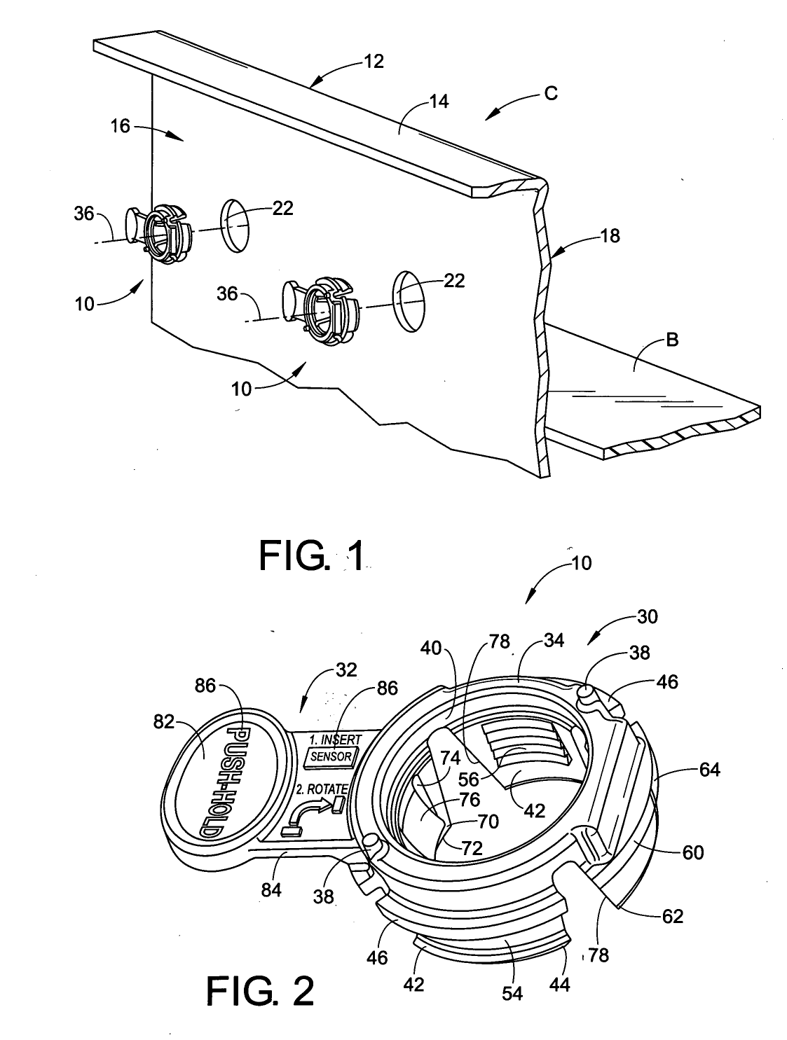

As mentioned above, the sensor mounting device 10 is received inside the mounting hole 22 of the conveyor side rail 12. The sensor mounting device 10 in the depicted embodiment is formed of a single piece of resilient material, such as, but not limited to plastic. With reference to the embodiment of FIG. 2, the sensor mounting device 10 generally includes a one-piece body having a ring-shaped portion 30 and a finger tab portion 32 that extends outwardly from the ring-shaped portion generally around the nine o'clock position of the ring-shaped portion. The sensor mounting device 10 quickly connects to the conveyor side rail 12 to provide for a quick connection of a sensor, which will be described in more detail below, to the conveyor system C.

The ring-shaped portion 30 of sensor mounting device 10 includes an outer ring 34. The outer ring 34 also defines a central axis 36 (FIG. 1) that when the device 10 is mounted to the side rail 12 aligns with a center point of the mounting hole 22. The central axis 36 is disposed normal to a plane defined by the mounting hole 22 in the conveyor side rail 12. With reference back to FIG. 2, rotation stop members 38 extend in a first axial direction from the outer ring 34. In the depicted embodiment, two rotational stop members 38 are provided each having a cylindrical pin-like configuration. One stop member 38 is disposed generally between the one o'clock and two o'clock position on the outer ring 34 and the other rotational stop member 38 is disposed generally between the seven o'clock and eight o'clock position on the outer ring 34. The rotational stop members 38 are radially spaced 180° from one another. The particular location of the stop members depends upon the dimensions of the sensor that the device 10 is configured to receive. The outer ring 34 includes an opening 40.

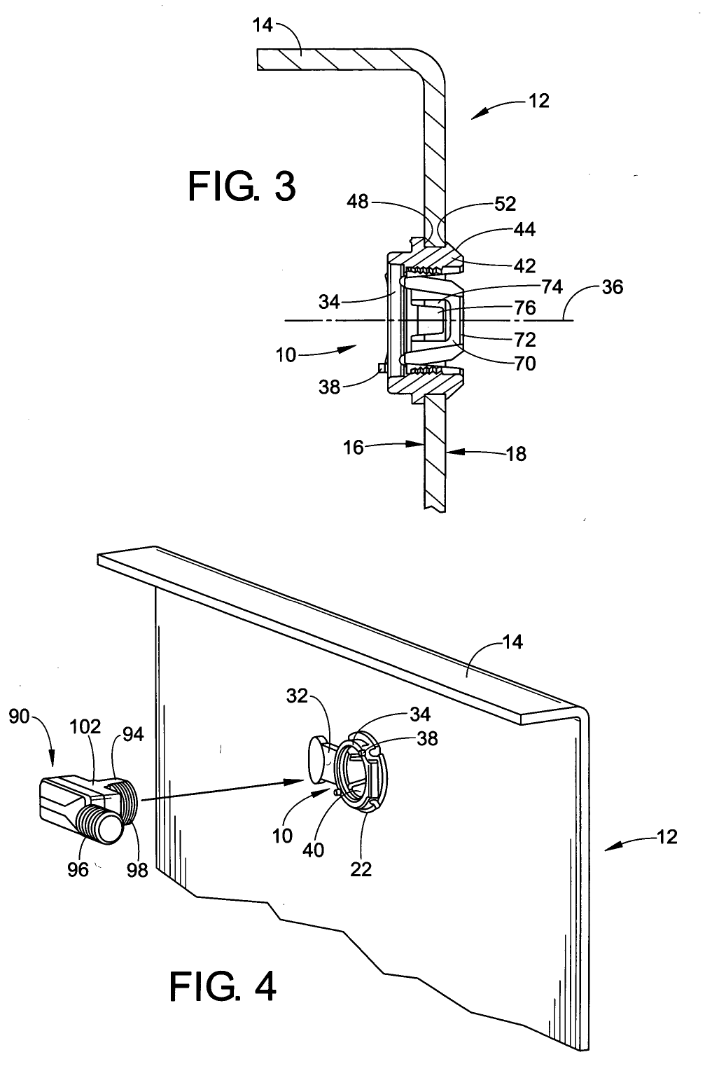

Upper and lower tabs 42 extend from the outer ring 34 in a second axial direction, which is opposite the first axial direction that the rotational stop members 38 extend. The tabs 42 are curved to match the circumference of the outer ring 34. The upper tab has the same configuration as the lower tab. Each tab 42 includes a ramped distal end 44 (see also FIG. 3). Since the sensor mounting device 10 is made of plastic, or other resilient material, the tabs 42 are flexible. The ramped distal end 42 ramps downwardly in the second axial direction towards the central axis 36. The ramped distal end 44 encourages movement of the tab 42 towards the central axis 36 as the sensor mounting device 10 is inserted into the mounting hole 12.

The mounting device 10 also includes shoulders 46 that extend radially outwardly from the upper and lower mounting tabs 42. The shoulders 46 are interposed between the outer ring 34 and the ramped distal ends 44 of each tab 42. As more clearly seen in FIG. 3, the shoulders 46 define a channel surface 48 and the ramped distal ends 42 also define a channel surface 52. A channel 54 (FIG. 2) is defined between the channel surfaces 48 and 52. With reference back to FIG. 3, the width of the channel 54, i.e. the dimension of the channel that is parallel to the central axis 36, measures approximately equal to or slightly larger than the thickness, e.g. the gauge, of the conveyor side rail 12. The width of the channel 54 can be different in other embodiments and can be configured to receive a conveyor side rail having a greater thickness, e.g. a higher gauge material, used to form a conveyor side rail 12.

With reference back to FIG. 2, a raised pad 56, which in the depicted embodiment comprises a plurality of ramped protuberances that extend towards the central axis and ramp downwardly towards the first axial direction, are disposed on an inner surface of each upper and lower tab 42. Each raised pad 56 engages the sensor that mounts to the sensor mounting device 10 in a manner that is described in more detail below.

With continued reference to FIG. 2, a first side tab 60 extends from the outer ring 34 in a same general direction as the upper and lower tabs 42. The first side tab 60 is curved to align with the circumference of the outer ring 34. The first side tab 60 is interposed along the circumference of the outer ring 34 between the upper and lower tabs 42 across from the finger tab portion 32, i.e. generally centered about a three o'clock position. The first side tab 60 includes a ramped distal end 62 similar to the ramped distal end 44 of the upper and lower tabs 42. The first side tab 60 also includes a shoulder 64 that is similar to the shoulder 46 of the upper and lower tabs 42. Even though it is not depicted, a channel which is similar to the channel 54, can be disposed between the ramped distal end 62 and the shoulder 64. This channel would have similar dimensions as the channel 54.

A second side tab 70 also extends from the outer ring 34 in a same general direction as the other tabs 44 and 60. The second side tab 70 is interposed between the upper and lower tabs 42 on a side of the outer ring 34 adjacent the finger tab portion 32. The second side tab 70 includes a ramped distal end 72 similar to the ramped distal ends described above. The second side tab 70 also includes a U-shaped cut out 74 formed along an axial direction that defines a lock tab 76. A distal portion of the lock tab 76, i.e. a portion furthest from the outer ring 34, extends radially towards the center line 36 (FIG. 3) of the ring 34.

As seen in FIG. 2, axially aligned gaps 78 exist between adjacent mount tabs 42, 60 and 70 up to where the mount tabs emanate from the outer ring 34. These gaps allow the tabs 42, 60 and 70 to deflect towards the central axis 36 (FIG. 1) of the ring-shaped portion 30 when the sensor mounting device 10 is inserted into the mounting hole 22. The ramp-shaped distal ends of the tabs encourage downward movement towards the central axis 36 until the conveyor side rail 12 slides over and into the channel 54. With the side rail 12 in the channel 54 the sensor mounting device 10 is fixed to the conveyor rail 12. Since the sensor mounting device 10 is not threaded into the mounting hole 22, but rather is simply pushed into the mounting hole, the channel 54 that receives the conveyor side rail 12 is annular in configuration (albeit discontinuous). This allows the sensor mounting device 10 to be rotated inside the opening 22 and the sensor mounting device 10 does not advance in either a forward or rearward axial direction. This facilitates mounting a sensor in the sensor mounting device, which will be described in more detail below.

The sensor mounting device can take other configurations. For example, as seen in FIG. 9, the location of the side tabs can be rearranged. The lock tab 76 can be disposed opposite the finger tab portion 32.

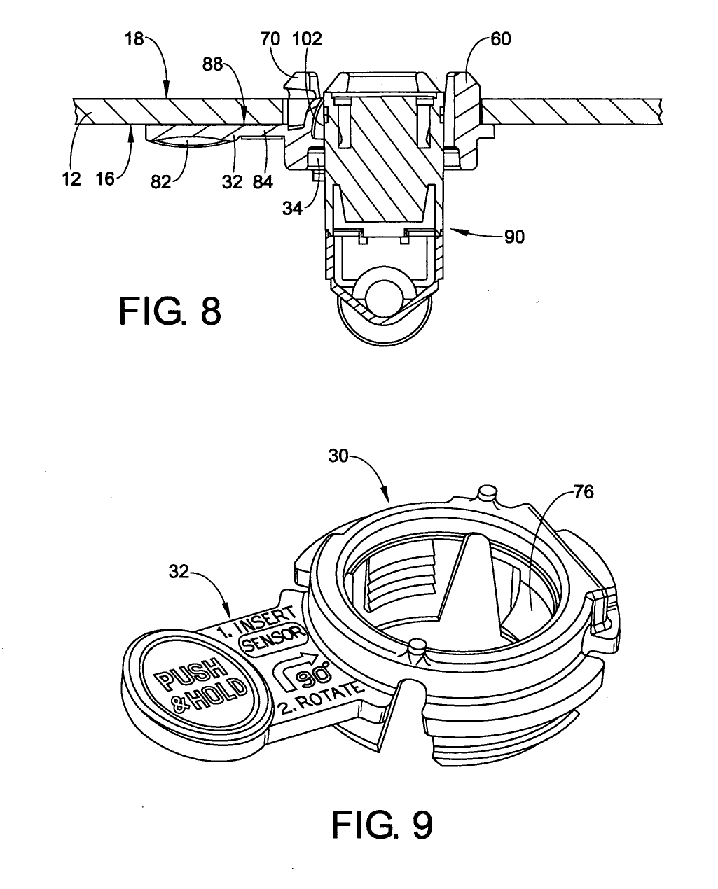

With reference again to FIG. 2, the finger tab portion 32 includes a distal elliptical portion 82 and a bar-like portion 84 interposed between the outer ring 34 and the elliptical portion. The elliptical portion 82 includes a concave surface to accommodate one's finger and/or thumb. Both the elliptical portion 82 and the bar-like portion 84 include markings 86 or other indicia that provide instructions for mounting the device 10 and the associated sensor, which will be described below. Indicia can also be provided to the desired configuration of the sensor mounting device 10 in the mounting hole 22. For example, a marking to indicate the top of the sensor mounting device 10 can be provided. As seen in FIG. 8, the rear surface 88 of the finger tab portion 32 is axially spaced from the distal ends of the mount tabs and is generally planar so that the rear surface rests firmly against the outer surface 16 of the side rail 12 when the sensor mounting device 10 is firmly attached in the mounting hole 22.

The sensor mounting device 10 can take various configurations other than those described. For example, the shape of the portion of the device that receives the sensor can be modified to accept a sensor having a configuration other than circular. Also, the shape of the portion of the device that fits into the mounting hole can be changed to fit into mounting holes having different configurations other than circular.

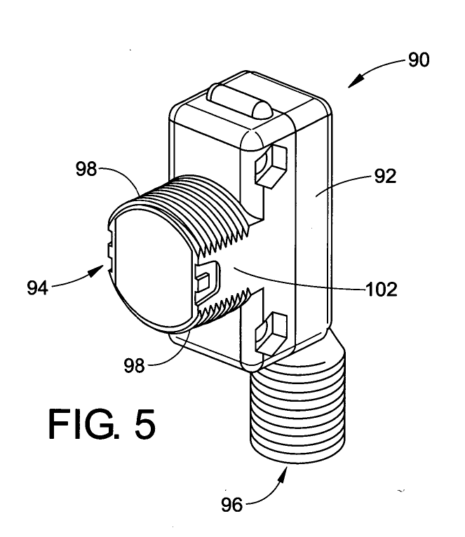

With reference to FIG. 4, the sensor mounting device 10 is received in the opening 22 of the conveyor side rail 12 and a sensor 90 quickly connects to the sensor mounting device 10 in a manner that will be described in more detail below. With reference to FIG. 5, one example of a sensor that can quickly attach to the sensor mounting device 10 is the sensor 90 which includes a housing 92 that houses electrical components. The housing 92 for the sensor depicted in FIG. 5 also includes a first male portion 94 and a second male portion 96. The first male portion 94 is generally centered about a first axis and the second male portion 96 is generally centered about a second axis that is perpendicular to the first axis. To mount the sensor 90 to the side rail 12, the first male portion 94 is received inside the opening 40 of the sensor mounting device 10. For the sensor 90 of the depicted embodiment, the first male portion 94 is cylindrical having generally obround bases. Curved surfaces 98 of the first male portion 94 are threaded and flattened surfaces 102 are not threaded. For this embodiment of the sensor 90, the flattened surfaces are generally parallel to a plane defined by the first axis and the second axis of the sensor. The second male portion 96 is generally cylindrical having circular bases. In this example, the outer surface 94 of the second male portion 96 is threaded to provide for a connection to a cable (not shown), for example. Other configurations for the second portion of the sensor can be provided.

To secure the sensor 90 in a conveyor system, the sensor mounting device 10 is inserted into mounting hole 22 of the side rail 12. As the device 10 is inserted into the mounting hole 22 the flexible tabs 42, 60 and 70 of the device flex towards the central axis 36 of the ring-shaped portion 32. Once the ramped ends 44 of the upper and lower tabs 42 are passed over the side rail 12, the tabs 42 flex radially outward so that the conveyor side rail 12 is received inside the channel 54 (see FIG. 3). Accordingly, the sensor mounting device 10 is restricted from moving either forward or rearward in the axial direction.

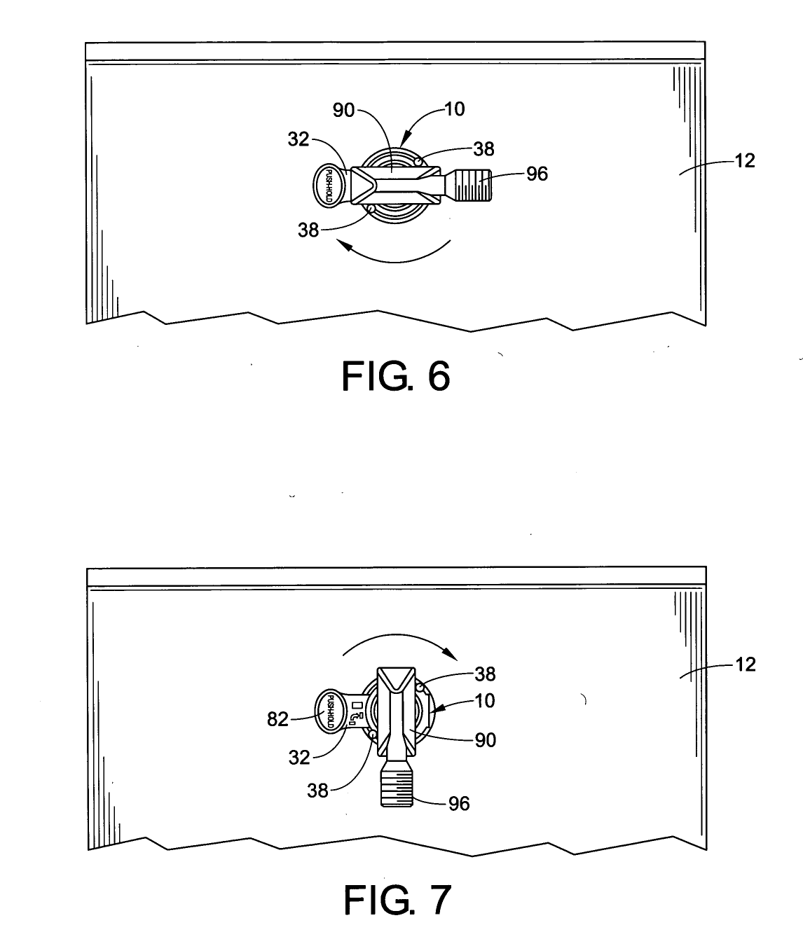

With reference to FIGS. 6 and 7, to secure the sensor 90 within side rail 12, the sensor 90 is inserted into the opening 40 of the sensor mounting device 10 on the outer surface of the side rail 12, i.e. from the same side the mounting device 10 was mounted, with the first male portion 94 (not visible in FIGS. 6 and 7) of the sensor being aligned with the finger tab portion 32 of the sensor mounting device. The finger tab portion 32 may be held down to ensure that the ring is steady for sensor installation. The first axis of the sensor, which is aligned with the first male portion 94, is also aligned with the central axis 36 of the ring 34 and opening 40. As shown in FIG. 6, with respect to the mounting hole 22, the finger tab portion 32 is generally aligned at the nine o'clock position and the second male portion 96 of the sensor 90 is generally aligned with the three o'clock position. To secure the sensor 90, once inserted the sensor is rotated 90° in a clockwise direction. Accordingly, the second male portion 86 is generally aligned with the six o'clock position of the mounting hole 22. The rotation stop members 38 limit the movement of the sensor further than about 90° as seen in FIG. 7. As seen in FIG. 8, with the sensor 90 rotated into the locked position (FIG. 7), the lock tab 76 of the second side tab 70 engages one of the flattened surfaces 102 of the first male portion 94 to lock the sensor in place. Also, as the sensor 90 is rotated towards the locked position the curved threaded surfaces 98 engage the raised pads 56 of the upper and lower tabs 42. The ramped protuberances of the raised pads 56 engage the threads of the threaded surfaces 98 and the flexible tabs 42 are further urged radially outward to engage the mounting hole 22 of side rail 12 in a tight engagement. Once the sensor 90 is rotated into the locked position the sensor mounting device 10 is inhibited from rotating due to the engagement of the raised tabs 56 and the threaded surfaces 98.

An assembly for a conveyor system that allows sensors to be quickly mounted to the conveyor system is described above. The system is very quick to install in that the sensor mounting device is quickly pushed into place and the sensor attaches to the sensor mounting device without requiring the technician to reach from an outer side to an inner side of the conveyor rail to attach the sensor to the conveyor side rail. It will be appreciated that various of the above-disclosed and other features and functions, or alternatives thereof, may be desirably combined into many other different systems or applications. Furthermore, the above-described components can take numerous other configurations other than those that have been described. The invention is not limited to only those configurations that have been described. Various presently unforeseen or unanticipated alternatives, modification, variations, or improvements therein may be subsequently made by those skilled in the art which are also intended to be encompassed by the following claims.

1. An assembly for a conveyor system comprising:
a conveyor side rail including an outer surface, an inner surface and an opening, the inner surface being the surface generally facing moving components of an associated conveyor system; and
a sensor mounting device received in the opening of the conveyor side rail, the sensor mounting device being configured to secure to the conveyor side rail via a resilient fit by inserting the sensor mounting device into the opening.

2. The assembly of claim 1, further including the sensor mounting device being a tool-less mounting device, wherein the tool-less mounting device is placed in a fixed rotatable relationship with the conveyor rail by hand insertion of the tool-less mounting device.

3. The assembly of claim 2, further including the tool-less mounting device being a single side connection tool-less mounting device, wherein the single side connection tool-less mounting device is configured to be placed in the fixed rotatable relationship with the conveyor side rail by hand insertion on a single side of the conveyor side rail.

4. The assembly of claim 1, wherein the sensor mounting device is configured to be rotated within the opening without moving along an axis that is generally normal to the inner surface of the conveyor side rail.

5. The assembly of claim 1, wherein the sensor mounting device includes a channel that receives at least a portion of the conveyor side rail.

6. The assembly of claim 1, wherein the sensor mounting device includes at least one resilient member adapted to move into an engaging relationship with the conveyor side rail upon insertion of an associated sensor.

7. The assembly of claim 6, wherein the resilient member includes an outer surface that contacts the conveyor side rail and an inner surface that contacts an associated sensor upon insertion of the associated sensor, the sensor mounting device further comprising at least one protuberance disposed on the inner surface of the resilient member and extending in a direction towards the associated sensor when the associated sensor is received inside of the sensor mounting device.

8. The assembly of claim 6, wherein the resilient member includes a ramped distal end.

9. The assembly of claim 1, wherein the sensor mounting device includes at least one rotational stop member configured to limit rotational movement of an associated sensor received by the sensor mounting device.

10. The assembly of claim 1, wherein the sensor mounting device includes a resilient tab that moves in a first direction during insertion of the device into the opening.

11. The assembly of claim 10, wherein the resilient tab moves in a second direction upon further insertion of the device into the opening.

12. In a conveyor system, a method of installing a sensor comprising:
inserting a sensor mounting device into an opening in a conveyor side rail from a first side of the side rail, the device including a flexible tab that is configured to engage the conveyor side rail, the device being inserted in a manner such that as the device is moving in an insertion direction the flexible tab moves in a first direction and as the device is moved further in the insertion direction the flexible tab moves in a second direction to engage the side rail; and
securing a sensor to the sensor mounting device.

13. The method of claim 12, wherein securing a sensor comprises rotating the sensor.

14. The method of claim 13, wherein rotating the sensor comprises rotating the sensor until a portion of the sensor contacts a rotation stop member of the device.

15. The method of claim 10, wherein securing the sensor comprises moving the sensor in a manner to urge the flexible tab into engaging the conveyor side rail.

16. A conveyor system assembly comprising:
a conveyor side rail for a conveyor system, the side rail including a mounting hole;
a sensor mounting device received in the mounting hole, the sensor mounting device including a body defining an opening configured to receive an associated sensor and a resilient tab that engages the side rail upon insertion of the sensor mounting device into the opening.

17. The assembly of claim 16, wherein the sensor mounting device is a one-piece unit.

18. The assembly of claim 16, further comprising a plurality of resilient tabs separated from one another by axially aligned gaps.

19. The assembly of claim 18, further comprising at least one lock tab extending toward a central axis of the opening, the lock tab being configured to contact the associated sensor.

20. The assembly of claim 16, wherein at least one of the body and the resilient tab includes a channel configured to receive the conveyor side rail such that when the conveyor side rail is received in the channel the sensor mounting device is limited in movement in two directions of an axis that is generally normal to the conveyor side rail.
